(19) United States
(12) Patent Application Publication
(10) Pub. No.: US 2008/0134576 A1
(43) Pub. Date: Jun. 12, 2008

(54) Tree watering device

(76) Inventors: Melinda Merryweather, La Jolla, CA (US); Stephen W. Roberts, La Jolla, CA (US)

Correspondence Address: MINTZ, LEVIN, COHN, FERRIS, GLOVSKY AND POPEO, P.C;ATTN: PATENT INTAKE CUSTOMER NO. 64046, ONE FINANCIAL CENTER, BOSTON, MA, 02111, US

(21) Appl. No.: 11/636,408

(22) Filed: Dec. 8, 2006

(51) Int. Cl. A01G 27/02

(52) U.S. Cl. 47/1.1 R

(57) ABSTRACT

A tree watering system is disclosed. An elongated conical funnel has a large top opening, a small bottom opening, and a side aperture proximate to but spaced at a distance from the small bottom opening. An elastic ring has a diameter that corresponds to a diameter of an inner surface of the funnel between the large top opening and the small bottom opening. The elastic ring is adapted to be fitted over a water container such as an emptied wine bottle, which is then inserted into the funnel, for automatically watering a bucket of a tree stand.

### BACKGROUND

Watering a tree, particularly one like a Christmas tree, that is supported in a stand and kept watered by a bowl of the stand, can be an arduous and imprecise activity. For example, Christmas trees tend to be of a pine variety, which can require substantial amounts of water to stay hydrated. Further, the amount of water required can vary based on atmospheric conditions, the length of time the tree has been in the stand, or the time since the tree has been cut from its roots.

To get an accurate account of how much water is being consumed by the tree, and thus how much water is needed on a regular basis, a user must manually check the bowl of the tree stand or pot. This typically requires the user to bend down and/or crawl under the tree, and often make what is at best a guess as to the amount of water required for the tree on a regular basis.

### SUMMARY

This document discloses a tree watering system to automatically keep a tree supplied with as much water as it needs, while obviating the need for a user to bend down and/or crawl under a tree to check whether the tree has sufficient water.

In one aspect, a tree watering system is disclosed including a funnel having a top opening, and including a tube connected to a bottom opening of the funnel. The tube has an open bottom end and a side aperture proximate to and spaced at a distance from the open bottom end.

In another aspect, a tree watering system includes an elongated conical funnel having a large top opening, a small bottom opening, and a side aperture proximate to but spaced at a distance from the small bottom opening. The system further includes an elastic ring having a diameter that corresponds to a diameter of an inner surface of the funnel between the large top opening and the small bottom opening.

In yet another aspect, a tree watering system includes a funnel having a top opening, a tube connected to a bottom opening of the funnel, where the tube has an open bottom end and a side aperture proximate to and spaced at a distance from the open bottom end, and a container for being filled with water. The container has a size and shape to fit at least partially into the funnel, and having an outer surface to abut an inner surface of the funnel, and can be a standard 750 ml wine bottle. The system further includes a gasket adapted to fit over the outer surface of the container to create a seal between the outer surface of the container and the inner surface of the funnel.

The details of one or more embodiments are set forth in the accompanying drawings and the description below. Other features and advantages will be apparent from the description and drawings, and from the claims.

### BRIEF DESCRIPTION OF THE DRAWINGS

These and other aspects will now be described in detail with reference to the following drawings.

FIG. 1 is an exploded view of a tree watering system.

FIG. 2 is an assembled view of a tree watering system.

FIG. 3 shows a tree watering system in use with a tree and bowl.

FIG. 4 illustrates the operation of a tree watering system.

Like reference symbols in the various drawings indicate like elements.

### DETAILED DESCRIPTION

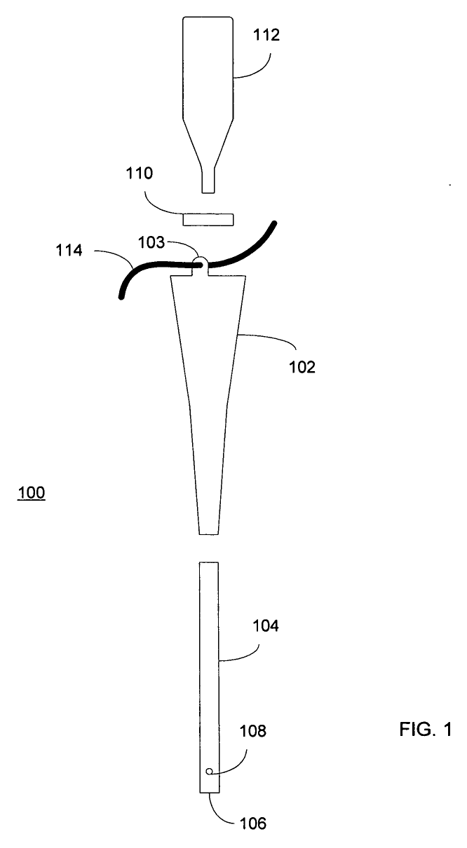

FIG. 1 shows a tree watering system 100 that can be placed into a pot or bowl of a tree stand to automatically maintain the water level in the bowl and thus keep the tree supplied with as much water as it needs, as well as enable a user to check on the water supply in the reservoir container without having to bend over or crawl under the tree.

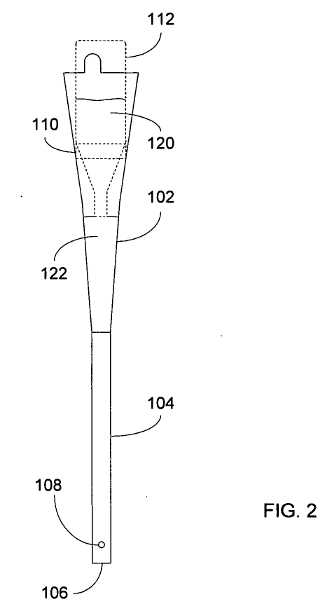

The tree watering system includes a funnel 102, a tube 104, and a gasket 110. As is also shown in FIG. 2, the gasket 110 is sized and adapted to be positioned around a part of the outer surface of a water-fillable container 112, preferably the shoulder or other curved surface of the container 112. The desired outer surface of the container 112 around which the gasket 110 is positioned will abut the inner wall of the funnel 102 when the container 112 is inserted into the funnel 102. The gasket 110 creates an air-tight, hydrostatic seal between the inner wall of the funnel 102 and an outer surface of the container 112. The gasket 112 can be a rubber band or ring that fits around the container 112, or which can be positioned in the funnel 102 and configured to receive the container 112. A film of petroleum jelly or other moist substance can be applied onto the gasket 110, particularly the outer surface of the gasket 110, to help ensure a water-tight seal between the container 112 and the funnel 102.

The funnel 102 is conical, having a large top opening and a smaller bottom opening. The funnel 102 is preferably elongated, and sized and adapted to receive the container 112 when it is filled with water and on which the gasket 110 has been placed, as shown in FIG. 2. The term “filled” refers to any amount of water in the container, and does not necessarily mean the container 112 is completely filled, but can be filled to any degree before the container 112 is inserted into the funnel 102. The container 112 can be a standard rounded glass wine bottle, but in other implementations can be a rigid plastic water bottle. In preferred implementations, the container 112 has a cylindrical container area, a shoulder leading to a narrow neck, and a single opening at the end of the neck.

The tube 104 is preferably elongated and cylindrical, with a top opening that is connected to the smaller bottom opening of the funnel 102. However, the tube 104 can be of any length so as to allow positioning of the top opening of the funnel 102 to a desired height. The tube 104 further includes an open bottom end 106 that acts as an outlet for water from the container 112, and a side aperture 108 proximate the open bottom end 106. The side aperture 108 can also be a water outlet, but also acts as an air inlet to the tube 104 and/or funnel 102 to displace accumulated water 120, 122 that has been placed in the container 112 and/or funnel 102 and/or tube 104. The side aperture 108 is positioned at a distance from the bottom opening 106 corresponding to a desired water depth in a tree container, as will be explained in further detail below.

In accordance with some implementations of the system 100, the funnel 102 includes an attachment member 103 extending from the funnel 102, via which the system 100 can be secured to a tree by a securing mechanism 114. In one example, the attachment member 103 includes a tab having a hole, and the securing mechanism 114 includes a wire or string. Other attachment members 103 and securing mechanisms 114 can be used.

The funnel 102 and tube 104 can be made of separate components that connect together or of a unitary piece. The funnel 102 and/or tube 104 can be made of any rigid or semi-rigid material such as acrylic, polyethylene, polypropylene, polyvinyl chloride, or other appropriate materials. In some implementations, the funnel 102 and/or tube 104 are coated with a decorative design, or colored so as to blend in with a tree or to correspond to a certain holiday or season.

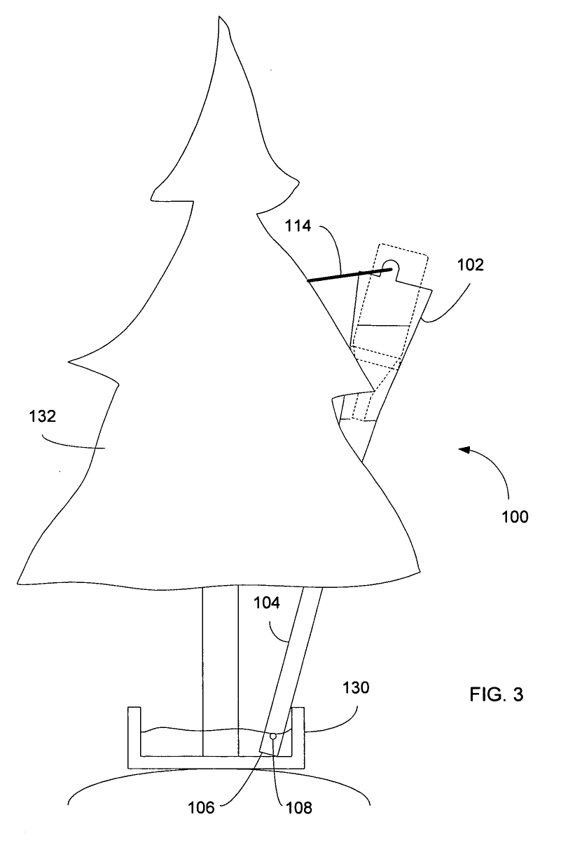

FIG. 3 illustrates the tree watering system 100 in use to provide water to a bowl 130 that supports a tree 132. The bowl 130 may be part of a tree stand, such as a Christmas tree stand or the like. The bowl 130 is able to hold a certain amount of water to nourish the tree 132. As illustrated, and in accordance with a preferred process, the tube 104 and funnel 102 assembly is passed down through the tree branches near to the trunk of the tree 132, with the open bottom end 106 of the tube 104 inserted into, and contacts, the bottom of the bowl 130.

Once the tube 104 and funnel 102 assembly is so positioned, it can be secured in its position and to the tree 132 by the securing mechanism 114. Then, the gasket 110 is stretched over the container 112, preferably over a shoulder of the container 112 that will abut the inner surface of the funnel 102. The gasket 110 can be moistened with water or petroleum jelly to augment the sealant characteristics of the gasket 110. The container 112 can then be filled with water, and the container 112 with the gasket 110 can be inserted into the top opening of the funnel 102 until an air and water-tight seal between the container 112 and the inner surface of the funnel 102 is achieved.

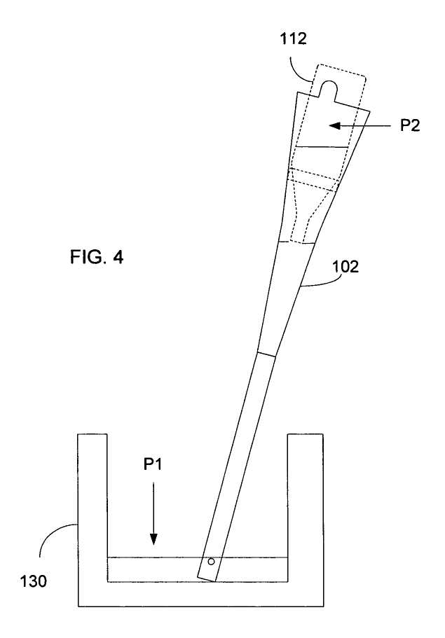

As is further illustrated with reference to FIG. 4, water from the container 112 will flow down the funnel 102 and through the tube 104 into the bowl 130, rise to a level of the side aperture 108 of the tube 104, after which the water stops flowing due to hydrostatic equilibrium between water in the system 100 and water in the bowl 130. Pressure on water in the bowl (P1) is at atmospheric pressure, while a pressure inside the container 112 is at a level less than P1, thereby providing a vacuum or suction to hold in water in the container 110 and the funnel 102/tube 104.

Once water in the bowl 132 retreats below the level of the side aperture 108 due to water uptake by the tree, air is allowed into the side aperture 108 and into the funnel 102/tube 104 and/or container 110, which then displaces a corresponding amount of water therein, to restore the water above the level of the side aperture 108. This process continues until all of the water originally from the container 100 is exhausted into the bowl 130. As long as there is a proper seal between the container 110 and the inner wall of the funnel 102, the pressure P2 in the container will always be less than the atmospheric pressure P1, to hold in water by vacuum force.

Although a few embodiments have been described in detail above, other modifications are possible. Other embodiments may be within the scope of the following claims.

What is claimed:

1. A tree watering system, comprising:
a funnel having a top opening; and
a tube connected to a bottom opening of the funnel, the tube having an open bottom end and a side aperture proximate to and spaced at a distance from the open bottom end.

2. A tree watering system in accordance with claim 1 wherein the funnel is sized to receive a water-filled container in the top opening, the water-filled container having one opening.

3. A tree watering system in accordance with claim 2, further comprising a gasket to create a seal between the water-filled container and an inner surface of the funnel.

4. A tree watering system in accordance with claim 1, further comprising an attachment member extending from the funnel.

5. A tree watering system in accordance with claim 4, further comprising a securing mechanism to attach the funnel to the tree via the attachment member.

6. A tree watering system in accordance with claim 5, wherein the securing mechanism includes a wire.

7. A tree watering system in accordance with claim 2, wherein the water-filled container is a wine bottle.

8. A tree watering system, comprising:
an elongated conical funnel having a large top opening, a small bottom opening, and a side aperture proximate to but spaced at a distance from the small bottom opening; and
an elastic ring having a diameter that corresponds to a diameter of an inner surface of the funnel between the large top opening and the small bottom opening.

9. A tree watering system in accordance with claim 8, further comprising a container for containing water and having one opening, the container being sized and shaped to fit into the funnel leading with the one opening and into the elastic ring, so as to form a seal between the container and the inner surface of the funnel.

10. A tree watering system in accordance with claim 8, wherein the funnel further includes a tubular portion between the large top opening and the small bottom opening.

11. A tree watering system, comprising:
a funnel having a top opening;
a tube connected to a bottom opening of the funnel, the tube having an open bottom end and a side aperture proximate to and spaced at a distance from the open bottom end;
a container for being filled with water, having a size and shape to fit at least partially into the funnel, and having an outer surface to abut an inner surface of the funnel; and
a gasket adapted to fit over the outer surface of the container to create a seal between the outer surface of the container and the inner surface of the funnel.

12. A tree watering system in accordance with claim 11, further comprising an attachment member extending from the funnel.

13. A tree watering system in accordance with claim 12, further comprising a securing mechanism to attach the funnel to the tree via the attachment member.

14. A tree watering system in accordance with claim 11, wherein the container is a wine bottle.

15. A tree watering system in accordance with claim 14, wherein the outer surface of the container includes a shoulder of the wine bottle.

16. A tree watering system in accordance with claim 11, wherein the gasket is a rubber band.

17. A tree watering system in accordance with claim 12, wherein the attachment member includes a tab with a hole.

18. A tree watering system in accordance with claim 17, wherein the securing mechanism includes a wire strip to be threaded through the hole of the tab.

19. A tree watering system in accordance with claim 11, wherein the funnel and tube are formed of plastic.

20. A tree watering system in accordance with claim 11, wherein the funnel and tube include a decorative outer surface.
